(19) United States
(12) Patent Application Publication
(10) Pub. No.: US 2017/0168581 A1
(43) Pub. Date: Jun. 15, 2017

(54) Method and Device for Controlling Operation Components Based on Somatosensory

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventor: Duan XU, Tianjin (CN)

(21) Appl. No.: 15/218,616

(22) Filed: Jul. 25, 2016

Related U.S. Application Data
(63) Continuation of application No. PCT/CN2016/088450, filed on Jul. 4, 2016.

(30) Foreign Application Priority Data
Dec. 10, 2015 (CN) 2015109261177

(51) Int. Cl. G06F 3/01

(52) U.S. Cl. CPC G06F 3/017; G06F 3/011; G06F 3/04815

(57) ABSTRACT

Disclosed are a method and electronic device for controlling an operation component based on somatosensory comprises: detecting gesture control information for the operation component; analyzing an operation event triggered by the gesture control information, wherein the operation event includes a Down event, a Move event and an Up event, and setting the Move event as an invalid event when the Move event is generated between the Down event and the Up event; and determining that the Down event and the Up event form a Click event so as to finish controlling on the operation component. The present disclosure avoids responding to other events formed by the Move event, accurately completing control of somatosensory on the operation component, and improving success rate of triggering corresponding operations by the gesture control information.

### CROSS-REFERENCE TO RELATED APPLICATIONS

This application is a continuation of International Application No. PCT/CN2016/088450, filed on Jul. 4, 2016, which is based upon and claims priority to Chinese Patent Application No. 201510926117.7, filed on Dec. 10, 2015, the entire contents of which are incorporated herein by reference.

### TECHNICAL FIELD

The present disclosure relates to the field of intelligent control technology, and in particular, to a method and device for controlling an operation component based on somatosensory.

### BACKGROUND

In the process of controlling an operation component by adopting a somatosensory technology, for example, controlling three-dimensional holographic projection, a complete Click event can be triggered by a gesture so as to achieve a control effect. A Click event includes a Down event and an Up event, the clicking behavior of the Click event includes two gestures, namely, pushing forward and pulling backward (pushing forward is equivalent to pressing down a mouse, and pulling backward is equivalent to lifting up a mouse), when pushing forward, sending the Down event of a corresponding point to an Android system is triggered; when pulling backward, sending the Up event of a corresponding point to the Android system is triggered; and the Down event and the Up event are combined to constitute a Click event.

However, in the control process of the prior art, technical problems exist as follows: taking an Android system as an example, a Click event is realized by a gesture on a desktop or in an application, it is low in accuracy to send a Click event of a corresponding position, and it is difficult to click on a target in case of a standard motion. For example, when clicking on an application icon, due to natural shaking of a person between the Down event and the Up event, typically, at this moment, Move event movement is formed, which is equivalent to that a Move event is successively sent after a Down event, and point coordinates of movement are transmitted, in this way, movement after the Down event can produce a response to entrance of a new event, which is equivalent to triggering of dragging after pressing down a mouse, formation conditions of Click events are removed so as not to produce Click events, thus Click events cannot be correctly triggered.

### SUMMARY

In order to solve the technical problem that accurate triggering always cannot be realized in the process of controlling an operation component by adopting the somatosensory technology in the prior art, the present disclosure provides a method and device for controlling an operation component based on somatosensory.

The method for controlling an operation component based on somatosensory according to the present disclosure, includes: detecting gesture control information for the operation component;analyzing an operation event triggered by the gesture control information, wherein the operation event includes a Down event, a Move event and an Up event, and setting the Move event as an invalid event when the Move event occurs between the Down event and the Up event; anddetermining that the Down event and the Up event form a Click event so as to finish controlling on the operation component.

In a possible embodiment, detecting the gesture control information for the operation component includes: acquiring position information and azimuth information of a gesture in a three-dimensional space in real time.

In a possible embodiment, analyzing the operation event triggered by the gesture control information, includes: analyzing the gesture control information, so as to obtain the azimuth information and the position information corresponding to the gesture, and determining the operation event triggered by the gesture in accordance with the azimuth information and the position information; wherein when the azimuth information is pushing forward and the position information reaches a preset value at the corresponding azimuth, determining that the pushing forward gesture triggers the Down event; when the azimuth information is dragging and the position information reaches a preset value at the corresponding azimuth, determining that the dragging gesture triggers the Move event; when the azimuth information is pulling backward and the position information reaches a preset value at the corresponding azimuth, determining that the pulling downward gesture triggers the Up event.

In a possible embodiment, setting the Move event as an invalid event, includes: refusing to send the Move event to the operation component. In a possible embodiment, setting the Move event as an invalid event, includes:refusing to respond to the Move event by the operation component.

In the process that an operator controls an operation component by adopting the somatosensory technology, due to unexpected dragging, a Click event cannot be accurately triggered, thus the operation component cannot be accurately controlled. The method and device for controlling an operation component based on somatosensory according to the present disclosure can be used for avoiding the above problem. By means of the technical solution of the present disclosure, in the processing procedure of the device on the gesture control information, a Down event and an Up event can be combined accurately so as to form a complete Click event, thus response to other events formed by a Move event is avoided, a control of somatosensory on the operation component is accurately finished and success rate of triggering corresponding operations by the gesture control information is improved.

The device for controlling an operation component based on somatosensory according to the present disclosure, includes:a detection and analysis module, configured to detect gesture control information for the operation component, analyze an operation event triggered by the gesture control information, where the operation event includes a Down event, a Move event and an Up event, and set the Move event as an invalid event when the Move event is generated between the Down event and the Up event;a component control module, configured to determine that the Down event and the Up event form a Click event so as to finish control on the operation component.

In a possible embodiment, detecting the gesture control information for the operation component, includes:acquiring position information and azimuth information of a gesture in a three-dimensional space in real time.

In a possible embodiment, analyzing the operation event triggered by the gesture control information, includes:analyzing the gesture control information to obtain the azimuth information and position information corresponding to the gesture, and determining the operation event triggered by the gesture in accordance with the azimuth information and the position information;where when the azimuth information is pushing forward and the position information reaches a preset value at the corresponding azimuth, determining that the pushing forward gesture triggers the Down event; when the azimuth information is dragging and the position information reaches a preset value at the corresponding azimuth, determining that the dragging gesture triggers the Move event; when the azimuth information is pulling backward and the position information reaches a preset value at the corresponding azimuth, determining that the pulling downward gesture triggers the Up event.

In a possible embodiment, setting the Move event as an invalid event, includes:Refusing to send the Move event to the operation component. In a possible embodiment, setting the Move event as an invalid event, includes:refusing to response to the Move event by the operation component.

In the process that an operation controls an operation component by adopting the somatosensory technology, due to unexpected dragging behavior, a Click event cannot be accurately triggered, thus the operation component cannot be accurately controlled. The device for controlling an operation component based on somatosensory according to the present disclosure can be used for avoiding the above problem. By means of the technical solution of the present disclosure, in the processing procedure of the device on the gesture control information, a Down event and an Up event can be combined accurately so as to form a complete Click event, and thus response to other events formed by a Move event is avoided, control of somatosensory on the operation component is accurately finished and success rate of triggering corresponding operations by the gesture control information is improved.

Other characteristics and advantages of the present disclosure will be described in the subsequent description, moreover, part of them becomes apparent from the description, or can be understood by implementing the present disclosure. The object and other advantages of the present disclosure can be achieved and obtained by structures specially indicated in the description, claims and accompanying drawings.

The technical solution of the present disclosure will be further described in detail in conjunction with the accompanying drawings and embodiments.

### BRIEF DESCRIPTION OF THE DRAWINGS

One or more embodiments are illustrated by way of example, and not by limitation, in the figures of the accompanying drawings, where elements having the same reference numeral designations represent like elements throughout. The drawings are not to scale, unless otherwise disclosed.

FIG. 1 is a flow chart of a method of the First Embodiment of the present disclosure;

FIG. 2 is a flow chart of a method of Second Embodiment of the present disclosure;

FIG. 3 is a schematic structural diagram of device of Third Embodiment of the present disclosure;

FIG. 4 is a schematic structural diagram of device of Fourth Embodiment of the present disclosure.

### DETAILED DESCRIPTION OF THE EMBODIMENTS

The preferred embodiments of the present disclosure will be explained below in conjunction with the accompanying drawings. It should be understood that the preferred embodiments described herein are merely used for illustrating and explaining the present disclosure, rather than limiting the present disclosure.

The specific embodiments of the present disclosure will be described in detail in combination with the following accompanying drawings, and it should be understood that the protection scope of the present disclosure is free of limitation of the specific embodiments.

In order to solve the technical problem that accurate triggering always cannot be realized in control of the operation component by adopting a somatosensory technology in the prior art, the present disclosure provides a method and device for controlling an operation component based on somatosensory.

### The First Embodiment

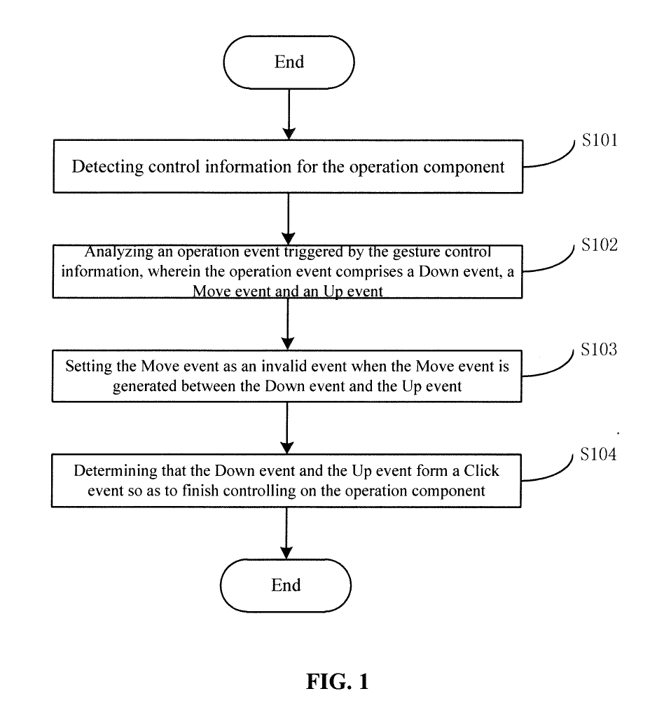

As shown in FIG. 1, a method for controlling an operation component based on somatosensory according to the present disclosure, includes the following steps: S101-S104.

In Step S101, the gesture control information for the operation component is detected.

Detecting the gesture control information for the operation component includes:acquiring position information and azimuth information of a gesture in a three-dimensional space in real time.

Taking a case that a gesture is adopted to perform sliding and page turning for a webpage of three-dimensional holographic projection as an example, the position information refers to the position of a hand projected to a page in sliding, and the azimuth information refers to azimuth change of a hand projected to a page in sliding. For example, a hand slides leftward to trigger the operation of turning to the next page, and slides rightward to trigger the operation of turning to the last page.

In Step S102, an operation event triggered by the gesture control information is analyzed, where the operation event includes a Down event, a Move event and an Up event.

When a hand slides leftward to trigger the operation of turning to the next page, actually, it triggers a complete Click event which includes a Down event and an Up event. An operation that a hand slides to a certain position from right to left is equivalent to triggering a Down event (being similar to clicking operation of the left button of a mouse), an operation that a hand slides leftward to a certain position and then leaves is equivalent to triggering an UP event (being similar to the clicking operation of the left button of a mouse and then releasing the left button), however, in the process of leftward sliding of a hand, in case of upward or downward inclination of a certain degree (being similar to dragging after clicking the left button of a mouse), a Move event is triggered equivalently.

In one embodiment, analyzing the operation event triggered by the gesture control information includes: analyzing the gesture control information to obtain azimuth information and position information corresponding to a gesture, and determining the operation event triggered by the gesture in accordance with the azimuth information and the position information.

When the azimuth information is pushing forward and the position information reaches a preset value at the corresponding azimuth, determining that the pushing forward gesture triggers the Down event; when the azimuth information is dragging and the position information reaches a preset value at the corresponding azimuth, determining that the dragging gesture triggers the Move event; when the azimuth information is pulling backward and the position information reaches a preset value at the corresponding azimuth, determining that the pulling downward gesture triggers the Up event.

Still taking the operation of adopting the gesture to perform page turning of a page as an example, when a hand slides from right to left, it is uncertain to trigger the Down event; if the situation that a hand slides leftwards in any case is regarded as triggering the Down event of page turning operation, it is extremely likely to cause wrong control on the page turning operation, for example, an operator is not intended to perform a page turning operation, but merely a hand slightly slides leftward by accident. Therefore, it is necessary to set that when the azimuth information is pushing forward (e.g. sliding leftward) and the position information reaches a preset value at the corresponding azimuth (e.g. sliding to a certain position or a sliding distance reaches a certain requirement), it is determined that the pushing forward gesture triggers the Down event.

In the same way, the above-mentioned corresponding limitations are made on triggering conditions of the Move event and the Up event.

In Step S103, the Move event is set as an invalid event when the Move event occurs between the Down event and the Up event.

It is incapable of accurately triggering a Click event due to the occurring of the Move event, and thus a page turning operation by gesture cannot work. The present disclosure aims to solve the problem of incapability of accurately triggering the Click event caused by unexpected generation of the Move event, in the process of triggering the above-mentioned Click event. According to the method proposed by the embodiments of the present disclosure, the Move event generated between the Down event and the Up event is set as an invalid event, namely, it is not allowed to influence triggering of the Click event by generation of the Move event.

In S104, the Down event and the Up event are determined to form a Click event so as to finish the controlling on the operation component.

Those skilled in the art should be understood that, as long as consecutive Down event and Up event are received, a Click event can be correspondingly triggered, thus, in the Step S103 of the embodiments of the present disclosure, after the Move event is set as an invalid event, the Click event can be accurately triggered according to the Down event and the Up event.

For example, in the process of sliding from right to left of a hand, the distance or position of sliding leftward reaches a preset value (being equivalent to triggering a Down event), but an operator upwards inclines by accident (being equivalent to triggering an Up event), and then lifts his hand up (being equivalent to triggering an Up event). As the device receives the leftward sliding Down event first, that is to say, it is deemed to require for performing the operation of turning to the next page, however, the upward inclination of a hand may be caused by the operation of sliding a page downward actually, hence, the device sets the inclination as an invalid operation, triggers a Click event after the Up event is received, thus completing the operation of turning to the next page.

In the embodiment of the present disclosure, setting the Move event as an invalid event includes two ways as follows: the Move event is not sent to the operation component and accordingly the operation component will not respond to the Move event; the operation component do not respond to the Move event, that is to say, the operation component has received the Move event but regards it as invalid, so the Move event do not influence the Down event and the Up event from triggering the Click event together.

In the process that an operator controls an operation component by adopting the somatosensory technology, due to unexpected dragging behavior, a Click event cannot be accurately triggered, thus the operation component cannot be accurately controlled. The method for controlling an operation component based on somatosensory according to the present disclosure can be used for avoiding the above problem. By means of the technical solution of the present disclosure, in the processing procedure of the device on the gesture control information, a Down event and an Up event can be combined accurately so as to form a complete Click event, however, response to other events formed by a Move event is avoided, control of somatosensory on the operation component is accurately finished and success rate of triggering corresponding operations by the gesture control information is improved.

### The Second Embodiment

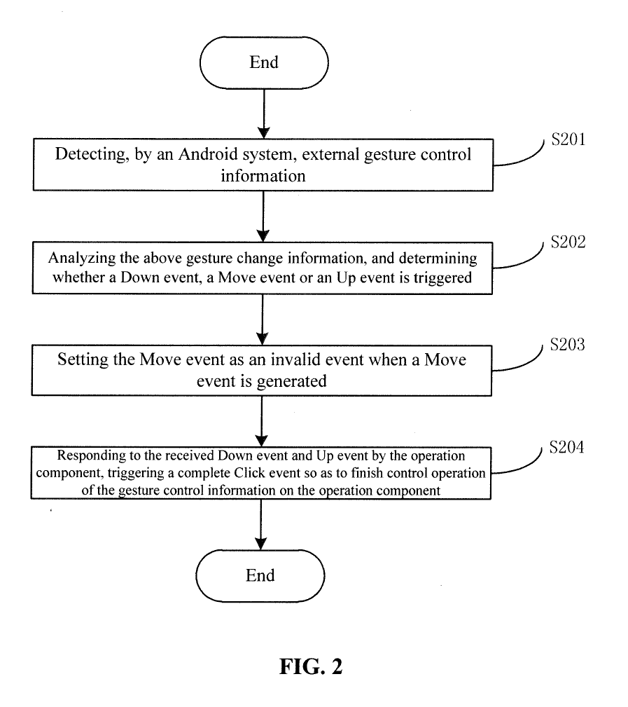

As shown in FIG. 2, the embodiment takes somatosensory control of an Android system (an intelligent operation system adopted by the operation component) as an example, so as to further illustrate the method in the Embodiment One, assuming that in the control process, a Move event is triggered, the embodiment includes the following steps: S201-S204.

In Step S201, the Android system detectsexternal gesture control information.

The embodiment takes an example of adopting a gesture to perform sliding leftward for page turning on a page of three-dimensional holographic projection, and the Step S201 is to detect the gesture change information of a hand in the page turning operation process.

In Step S202, the above-mentioned gesture change information is analyzed, and whether the Down event, Move event or Up event is triggered is determined.

Assuming that in the embodiment, in the process of sliding from right to left of a hand, the distance or position of sliding leftward reaches a preset value (being equivalent to triggering a Down event), but an operator upwards inclines by accident (being equivalent to triggering a Move event), and then lifts his hand up (being equivalent to triggering an Up event).

In Step S203, if the Move event is generated, the Move event is set as an invalid event. To trigger a complete Click event so as to achieve a page-turning effect on a page, the present disclosure puts forwards two methods for setting the Move event as an invalid event as follows.

The Move event following the Down event is shielded, after the Move event following the Down event occurs, the Android system does not transmit the Move event to the operation component any more, and will transmit an Up event after receiving the up event, in this way, the operation component only responds to the Down event and the Up event, and consequently the success rate of Click is greatly increased.

The Android system transmits the Move event to the operation component, but the operation component removes the Move event, namely does not respond to the Move event, in this way, even if the operation component receives the Move event, it will shield it until the Up event is received, so for the operation component, only the Down event and the Up event are received, thereby avoiding event response caused by the Down event, and the success rate of triggering the Click event is greatly increased. By virtue of optimizing treatment on the Move event after the Down event, the accuracy of clicking is obviously improved.

In Step S204, the operation component responds to the received

Down event and Up event and triggers a complete Click event, so as to complete control operation of the gesture control information on the operation component.

The embodiment is used for detailed illustration for the method in the Embodiment One under a specific application scenario of the Android system, merely illustrating the method in the present disclosure, rather than limiting the protection scope of the present disclosure. It should be appreciated by those skilled in the art that technical means that can realize an effect of setting the Move event between the Down event and the Up event as an invalid event, namely, merely responding to a down event or an up event rather than a Move event between the down event and the up event, should all fall into the protection scope of the present disclosure, without limitations from the specific embodiments of the present disclosure.

The embodiment possesses all advantageous technical effects of the First Embodiment, so it is not repeated redundantly herein.

### The Third Embodiment

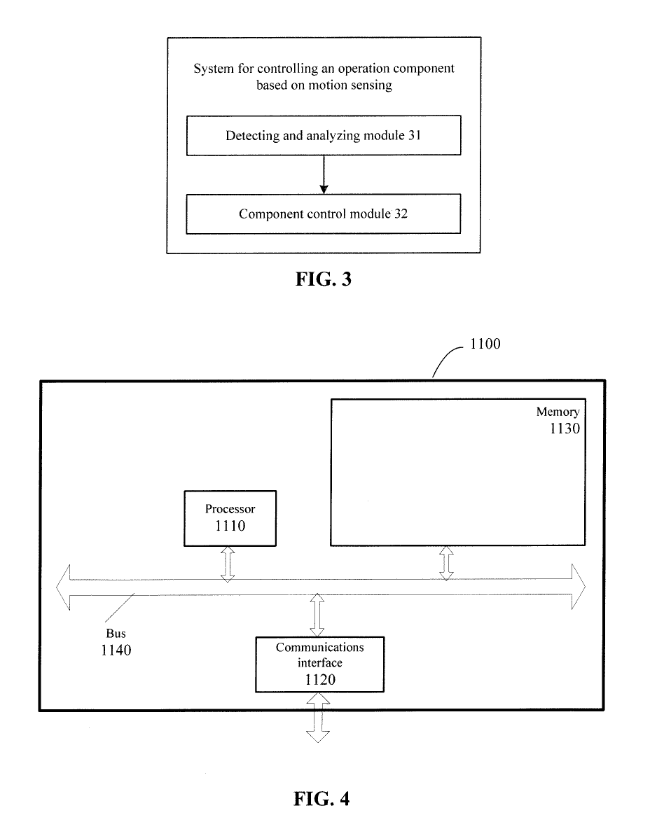

As shown in FIG. 3, the device for controlling an operation component based on somatosensory according to the present disclosure, includes: a detecting and analyzing module 31, a component control module 32,

The detecting and analyzing module 31 is configured to detect gesture control information for the operation component, analyze an operation event triggered by the gesture control information, wherein the operation event includes a Down event, a Move event and an Up event, and setting the Move event as an invalid event when the Move event is generated between the Down event and the Up event;

The component control module 32 is configured to determine that the Down event and the Up event form a Click event so as to complete control on the operation component.

In one embodiment, detecting the gesture control information for the operation component, includes: acquiring position information and azimuth information of a gesture in a three-dimensional space in real time.

In one embodiment, analyzing the operation event triggered by the gesture control information, includes: analyzing the gesture control information, so as to obtain the azimuth information and the position information corresponding to the gesture, and determining the operation event triggered by the gesture in accordance with the azimuth information and the position information; wherein when the azimuth information is pushing forward and the position information reaches a preset value at the corresponding azimuth, determining that the pushing forward gesture triggers the Down event; when the azimuth information is dragging and the position information reaches a preset value at the corresponding azimuth, determining that the dragging gesture triggers the Move event; when the azimuth information is pulling forward and the position information reaches a preset value at the corresponding azimuth, determining that the pulling downward gesture triggers the Up event.

In one embodiment, setting the Move event as an invalid event, includes:refusing to send the Move event to the operation component. In one embodiment, setting the Move event as an invalid event, includes: refusing to respond to the Move event by the operation component.

In the process that an operator controls an operation component by adopting the somatosensory technology, due to unexpected dragging behavior, a Click event cannot be accurately triggered, thus operation component cannot be accurately controlled. The device for controlling an operation component by somatosensory in the present disclosure can be used for avoiding the above problem. By means of the technical solution of the present disclosure, in the processing procedure of the device on the gesture control information, a Down event and an Up event can be combined accurately so as to form a complete Click event, however, response to other events formed by a Move event is avoided, control of somatosensory on the operation component is accurately finished and success rate of triggering corresponding operations by the gesture control information is improved.

There are various different modes of specific embodiments in the present disclosure, the technical solutions of the present disclosure are illustrated through taking the FIG. 1 to FIG. 3 as examples in conjunction with the accompanying drawings, which does not mean that all specific examples used in the present disclosure are only limited to specific flows or embodiment structures, it should be understood that by those of ordinary skill in the art the specific embodiments provided above are some examples of multiple preferred usages, and any embodiment that can embody the claims of the present disclosure should fall into the protection scope of technical solutions of the present disclosure.

Finally, it should be noted that, the above mentioned is merely the preferred embodiments of the present disclosure, and is not used for limiting the present disclosure. Although the present disclosure is illustrated in detail with reference to the foregoing embodiments, for those skilled in the art, modifications on the technical solutions recorded by the foregoing embodiments, or equivalent substitutions to part of technical features therein also can be made. Within the spirit and principle of the present disclosure, all modifications, equivalent substitutions, improvements and the like made should fall into the protection scope of the present disclosure.

### The Fourth Embodiment

FIG. 4 is a block diagram of the structure of device for controlling an operation component based on somatosensory according to another embodiment of the present disclosure. The device 1100 may be a host server with computing capability, a personal computer (PC), a portable computer or a terminal, or the like. The specific embodiments of the present disclosure do not make limitations to specific implementations of computational nodes.

The device 1100 includes a processor 1110, a communications interface 1120, a memory 1130 and a bus 1140, where the processor 1110, the communications interface 1120 and the memory 1130 implement intercommunication via the bus 1140.

The communications interface 1120 is configured to communicate with a network element, wherein the network element includes a virtual machine management center, a shared memory and the like.

The processor 1110 is configured to execute an instruction. The processor 1110 may be a CPU (Central Processing Unit), or an ASIC (Application Specific Integrated Circuit) or one or more integrated circuits configured to implement embodiments of the present disclosure.

The memory 1130 is configured to store a file. The memory 1130 may include a high-speed RAM memory, and may also include a non-volatile memory, such as at least one magnetic disk memory. The memory 1130 may also be a memory array. The memory 1130 may be divided into blocks, and the blocks may be combined into a virtual volume according to a particular rule.

In one possible implementation, the above instruction may be instruction codes containing computer operating instructions. The instruction is specially configured to perform the following steps: detecting gesture control information for the operation component; analyzing an operation event triggered by the gesture control information, wherein the operation event includes a Down event, a Move event and an Up event, and setting the Move event as an invalid event when the Move event is generated between the Down event and the Up event; determining that the Down event and the Up event form a Click event so as to finish controlling on the operation component.

In a possible implementation, detecting the gesture control information for the operation component includes: acquiring position information and azimuth information of a gesture in a three-dimensional space in real time; in a possible implementation, analyzing the operation event triggered by the gesture control information, includes: analyzing the gesture control information, so as to obtain the azimuth information and the position information corresponding to the gesture, and determining the operation event triggered by the gesture in accordance with the azimuth information and the position information; wherein when the azimuth information is pushing forward and the position information reaches a preset value at the corresponding azimuth, determining that the pushing forward gesture triggers the Down event; when the azimuth information is dragging and the position information reaches a preset value at the corresponding azimuth, determining that the dragging gesture triggers the Move event; when the azimuth information is pulling backward and the position information reaches a preset value at the corresponding azimuth, determining that the pulling downward gesture triggers the Up event.

In a possible implementation, setting the Move event as an invalid event, includes: refusing to send the Move event to the operation component; in a possible implementation, setting the Move event as an invalid event, includes: refusing to respond to the Move event by the operation component.

Those skilled in the art should understand that, the embodiment of the present disclosure can be provided as a method, a system or a computer instruction product. Therefore, the present disclosure may be in form of a full hardware embodiment, a full software embodiment, or an embodiment of combination of software and hardware. Moreover, the present disclosure may be also in form of a computer instruction product implemented on one or more computer usable storage media (including but not limited to a magnetic disk memory, an optical memory and the like) containing a computer usable instruction code. That is to say, the embodiment of the present invention also provides a non-transitory computer-readable storage medium storing executable instructions that, when executed by an electronic device, cause the electronic device to execute the processing method in the case of any method embodiment mentioned above.

The present disclosure is described with reference to the flowchart and/or block diagram of the method, system (system) and computer instruction product. It should be understood that each flow and/or block of the flowchart and/or the block diagram as well as a combination of flows and/or blocks of the flowchart and/or the block diagram may be implemented by computer program instructions. These computer program instructions may be provided to a general-purpose computer, a dedicated computer, an embedded processor or processors of other programmable data processing device to generate a machine, such that device configured to implement functions of one or more flows in the flowchart and/or one block or more blocks in the block diagram may be generated by the instructions executed on a computer or processors of other programmable data processing device.

These computer instructions may also be stored in a computer readable memory which can direct the computer or other programmable data processing devices to operate in a specific mode, so as to enable the instructions stored in the computer readable memory to generate a manufacture product containing an instruction device. The instruction device can implement the function designated in one or more flows in the flowchart and/or one block or more blocks in the block diagram.

These computer instructions may also be installed on a computer or other programmable data processing devices so that a series of operation step can be carried out on the computer or other programmable data processing devices to generate processing implemented by the computer; therefore, instructions executed on the computer or other programmable data processing devices provide steps configured to implement the function designated in one or more flows in the flowchart and/or one block or more blocks in the block diagram.

The device according to the embodiments of the present disclosure can exist in various forms, including but not limited to:

Mobile communication device: this type of device is featured with a mobile communication function, and is mainly used for providing voice and data communication. These terminals include: a smartphone (e.g. iPhone), a multimedia phone, a functionality phone, and a low-end phone, and the like.

Ultra mobile personal computer device: this type of device belongs to the range of personal computers, and is provided with computation and processing functions, and typically has a mobile internet characteristic. These terminals include: PDA, MID and UMPC device, and the like, such as iPad.

Portable recreation device: this type of device can display and display multimedia contents and include voice and audio players (such as iPod), handheld game players, e-books, intelligent toys and portable vehicle navigation device.

Servers: apparatus can provide computing service, and servers include: processors, rigid disks, memories, system buses and the like, architecture of the servers is similar to that of a general-purpose computer, however, due to requirement for providing high-quality and reliable service, the requirements on processing capability, stability, reliability, safety, expandability, manageability and other aspects are higher.

Other electronic devices with a data interaction function.

The device embodiments described above are merely exemplary, wherein units described as separated components can be or cannot be separated physically, components as unit display can be or cannot be physical units, namely can be located on one position, or can be distributed on multiple network units. The object of the solution of the embodiments can be achieved by selecting part or all modules as required.

What is claimed is:

1. A method for controlling an operation component based on somatosensory, comprising:
detecting gesture control information for the operation component;
analyzing an operation event triggered by the gesture control information,
wherein the operation event comprises a Down event, a Move event and an Up event;
setting the Move event as an invalid event when the Move event is generated between the Down event and the Up event; and
determining that the Down event and the Up event form a Click event so as to finish the controlling to the operation component.

2. The method of claim 1, wherein detecting the gesture control information for the operation component comprises:
acquiring a position information and an azimuth information of a gesture in a three-dimensional space in real time.

3. The method of claim 1, wherein the analyzing the operation event triggered by the gesture control information comprises:
analyzing the gesture control information, so as to obtain an azimuth information and a position information corresponding to the gesture, and determining the operation event triggered by the gesture in accordance with the azimuth information and the position information;
wherein when the azimuth information is pushing forward and the position information reaches a preset value at the corresponding azimuth, determining a pushing forward gesture triggers the Down event; when the azimuth information is dragging and the position information reaches a preset value at the corresponding azimuth, determining a dragging gesture triggers the Move event;
when the azimuth information is pulling backward and the position information reaches a preset value at the corresponding azimuth, determining a pulling downward gesture triggers the Up event.

4. The method of claim 3, wherein the setting the Move event as an invalid event comprises:
refusing to send the Move event to the operation component.

5. The method of claim 3, wherein the setting the Move event as an invalid event comprises:
refusing to respond to the Move event by the operation component.

6. An electronic device for controlling an operation component based on somatosensory, comprising:
at least one processor; and
a memory communicably connected with the at least one processor for storing instructions executable by the at least one processor, wherein execution of the instructions by the at least one processor causes the at least one processor to:
detect gesture control information for the operation component;
analyze an operation event triggered by the gesture control information, wherein the operation event comprises a Down event, a Move event and an Up event; set the Move event as an invalid event when the Move event is generated between the Down event and the Up event; and
determine that the Down event and the Up event form a Click event so as to finish the controlling to the operation component.

7. The electronic device of claim 6,wherein the processor is configured to read the instruction code stored in the memory and execute:
acquire a position information and an azimuth information of a gesture in a three-dimensional space in real time.

8. The electronic device of claim 6, wherein the processor is configured to read the instruction code stored in the memory and execute:
analyze the gesture control information, so as to obtain an azimuth information and a position information corresponding to the gesture, and determine the operation event triggered by the gesture in accordance with the azimuth information and the position information;
wherein when the azimuth information is pushing forward and the position information reaches a preset value at the corresponding azimuth, determine a pushing forward gesture triggers the Down event; when the azimuth information is dragging and the position information reaches a preset value at the corresponding azimuth, determining a dragging gesture triggers the Move event;
when the azimuth information is pulling backward and the position information reaches a preset value at the corresponding azimuth, determine a pulling downward gesture triggers the Up event.

9. The electronic device of claim 8, wherein the processor is configured to read the instruction code stored in the memory and execute:
refuse to send the Move event to the operation component.

10. The electronic device of claim 8, wherein the processor is configured to read the instruction code stored in the memory and execute:
refuse to respond to the Move event by the operation component.

11. A non-transitory computer-readable storage medium storing executable instructions that, when executed by an electronic device, cause the electronic device to:
detect gesture control information for the operation component;
analyze an operation event triggered by the gesture control information, wherein the operation event comprises a Down event, a Move event and an Up event;
set the Move event as an invalid event when the Move event is generated between the Down event and the Up event; and
determine that the Down event and the Up event form a Click event so as to finish the controlling to the operation component.

12. The electronic device of claim 6,wherein when execute the instruction, cause the electronic device to:
acquire a position information and an azimuth information of a gesture in a three-dimensional space in real time.

13. The electronic device of claim 6, wherein when execute the instruction, cause the electronic device to:
analyze the gesture control information, so as to obtain an azimuth information and a position information corresponding to the gesture, and determine the operation event triggered by the gesture in accordance with the azimuth information and the position information;
wherein when the azimuth information is pushing forward and the position information reaches a preset value at the corresponding azimuth, determine a pushing forward gesture triggers the Down event; when the azimuth information is dragging and the position information reaches a preset value at the corresponding azimuth, determine a dragging gesture triggers the Move event;
when the azimuth information is pulling backward and the position information reaches a preset value at the corresponding azimuth, determine a pulling downward gesture triggers the Up event.

14. The electronic device of claim 8, wherein when execute the instruction, cause the electronic device to:
refuse to send the Move event to the operation component.

15. The electronic device of claim 8, wherein when execute the instruction, cause the electronic device to:
refuse to respond to the Move event by the operation component.
